(19) United States
(12) Patent Application Publication
(10) Pub. No.: US 2003/0078956 A1
(43) Pub. Date: Apr. 24, 2003

(54) Multi-threaded design mechanism and methodology for dynamic menu management in GUI application

(76) Inventors: Aruna Ravichandran, Santa Clara, CA (US); Alexander Ryzhov, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 09/983,405

(22) Filed: Oct. 24, 2001

(51) Int. Cl. G06F 9/00

(52) U.S. Cl. 709/107; 709/320

(57) ABSTRACT

A system and method that allows dynamic menu management when a user selects a graphical object using inter-thread communications. The present invention is a part of a program, or graphical user interface (GUI), designed to execute in a windowing system such as Microsoft Windows or X-Windows. The GUI performs time-consuming computations when a user selects an object. The mechanism described herein provides immediate response to the user actions at all times regarding the computations caused by selection changes. When a user makes a second selection prior to completion of the time-consuming computations resulting from the first selection, the first selection thread is gracefully terminated and the second selection thread is allowed to run.

### TECHNICAL FIELD

The present invention relates to the efficient operation of graphical user interfaces (GUIs), and more particularly to a mechanism that allows dynamic menu management when a user selects a graphical object using inter-thread communications.

### BACKGROUND

It is typical in graphical user interfaces (GUIs) for a current operation or process to be incomplete when a user chooses to select a new operation. For instance, a user might select a menu option that requires extensive database querying. While this querying occurs, the system typically displays an hourglass in place of the cursor or a “please wait” message. Many such operations take a long time to complete and do not allow the user to cancel and select another operation, requiring the user to await the completion of an undesired task. Prior art solutions require that the undesired task, or thread, be fully completed before another selection request can be processed. This results in very poor performance and can also hang, or lock up, the GUI.

Also typical is for menus and pop-up menus to be predefined. The menus are not dynamically generated based on selection criteria or active processes. Thus, there is no built-in mechanism to cancel a menu-display operation, once initiated. If a user selects a menu or pop-up menu, the entire display of that menu will need to complete before another alternative task is selected.

### SUMMARY

It is an aspect of the present invention to provide an efficient mechanism for allowing dynamic menu management when a user selects a graphical object. It is another aspect of the invention to allow the dynamic generation of a menu to exit gracefully if the user selects a new graphical object prior to the completion of the first task of generating a menu.

These and other aspects and embodiments of the present invention are achieved in a system using inter-thread communication. The preferred embodiment is implemented in a JAVA™ environment. (JAVA is a trademark of Sun Microsystems, Inc.). These and other objects are alternatively achieved in another embodiment of the invention for use in manipulation of structures or layouts that are not menus.

According to the invention, a menu management system is utilized having the following component: user interface, query engine, display object module, selection thread, and selection manager. It will be apparent to one skilled in the art that the functions performed by the menu management system may be implemented in separate or multi-function component. In a preferred embodiment, the user interface component is used for receiving user input and displaying and selecting graphics objects. The query engine is used to query a database to retrieve status and data related to graphic objects. The display object module is used to manage display object structure and display the display object items in a visual display. The selection thread is used to request queries in synchronous mode to the query engine, and to add items to display objects corresponding to an executing thread. The display object items are based on data retrieved by the query engine and a selected graphic object. The selection manager is used to manage execution and termination of program threads, and to remove display object items corresponding to terminated threads via the display object module.

The menu management system is used in conjunction with a GUI. First a graphical object on a graphical user interface display is selected. This selection may be either automatic or manual. The database is queried for data corresponding to the selected graphical object. A display object is then dynamically generating based on the selected graphical object and corresponding data retrieved during the database query. The dynamic generation of the display may be interrupted if a second graphical object is selected prior to completion of the generation of the display object. Finally, the display object is displayed in the GUI display device.

### DESCRIPTION OF THE DRAWINGS

The invention will be described in detail in the following description of preferred embodiments with reference to the following figures wherein:

FIGS. 1A and 1B are block diagrams showing a dynamically generated pop-up menu associated with a selected object;

FIG. 2 is a block diagram of a service manager component and its relationship to other program components;

FIG. 3 is a flow chart illustrating a main loop run by a selection manager; and

FIG. 4 is a flow chart illustrating a selection thread process.

### DETAILED DESCRIPTION

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

In the present invention, the system and method are described for the menu management routines triggered by selection of graphical objects. Menus are displayed with data that corresponds to an object selected and its related state or other corresponding data. In the prior art, menus in a graphic user interface (GUI) are typically static, or pre-defined. When a display object is selected, for instance, a pre-defined menu or other display feature is generated. The operation of displaying the object menu can be very time-consuming.

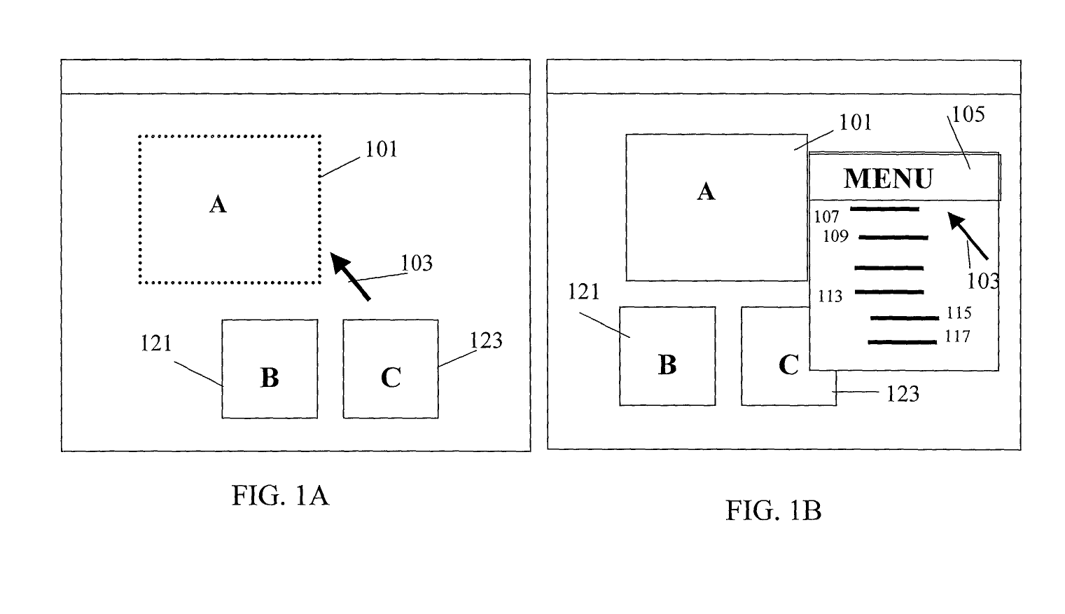

Referring now to the drawings, and in particular to FIG. 1A, there is shown a simplified GUI display with objects A 101, B 121 and C 123. The user selects object A 101. A preferred method for selecting is pointing (with cursor 103) and then clicking to use a pointing device, such as a mouse. Other methods, for instance, keyboard navigation, may be used. Some selection operations, a right-click on an object, for instance, also cause bringing up a customized pop-up menu. Referring to FIG. 1B, there is shown a simplified pop-up menu 105 as would be displayed after right-clicking on object A 101. In one embodiment, the pop-up menu 105 has several associated items 107, 109, 111, 113, 115, and 117. These items are not pre-determined, but are dependent on the object selected, in this case, object A 101, and state information of object A 101 or related objects, i.e., B 121 and C 123.

When Object A 101 is selected, as shown in FIG. 1A, the GUI process begins a series of queries to determine which items should be displayed in pop-up menu 105, as shown in FIG. 1B. The queries can be extremely time-consuming, based on the GUI application. In systems of the prior art, the user would be precluded from canceling the menu display operation or selecting another object, or performing another task until the menu pop-up was fully displayed. Thus, all queries must be executed before canceling is permitted. This results in unnecessary delay and annoyance for the user.

In an exemplary embodiment, the present invention is integrated with the HP ServiceGuard clustering solution product, available from Hewlett-Packard Company. ServiceGuard uses a graphical user interface (GUI), which shows a tree of graphical objects and a graph of graphical objects called “map”. Each graphical object shown in the map or tree can be selected. Further, information corresponding to a selected graphical object can be displayed in property sheet panels. In this exemplary embodiment, the three typical types of graphical objects are: cluster, node, and package. There are several menus associated with the objects displayed in the ServiceGuard product. The menu type depends on the operations that can be performed on the selected object. The creation of these administration menus is dynamic and based on the selected object.

In the exemplary embodiment, the menu creation process requires execution of numerous SQL database queries in order to retrieve the state and associated element information for use in the custom menu. The exemplary embodiment is implemented in JAVA™ and uses JAVA™ threads to enable the interruption of menu population.

JAVA™ enables an application to have multiple threads of execution within a program. Thread synchronization in JAVA is typically accomplished by having each thread obtain a lock on an object before being permitted to modify it. While any one thread holds a lock, another thread that requests the lock has to wait until the first thread completes and releases its lock on the object. Every JAVA™ object has the fundamental ability to provide such a locking capability. It will be apparent to one skilled in the art how to implement the method of the present invention, as more fully described below, using JAVA™ threads. Further, it will also be apparent to one skilled in the art how to implement the present invention using other object-oriented environments that enable multi-threaded processes.

Generally, this mechanism is a part of a program designed to execute in a windowing system, such as Microsoft® Windows™ or X-Window. (Microsoft and Windows are trademarks of Microsoft Corporation. X Window was developed by Massachusetts Institute of Technology.). As is understood in the art, the program must perform time-consuming computations each time the user selects an object. Only after these computations are complete, can the program enable certain menu items. On the other hand, the program must provide quick response to the user and not block input until the queries complete. In one embodiment of the present invention, however, a “selection manager” provides immediate response to the user's actions at all times, regardless of the computations caused by selection changes. It will be apparent to one skilled in the art that display objects (i.e., graphic images, tables, etc.) other than menus may be dynamically created.

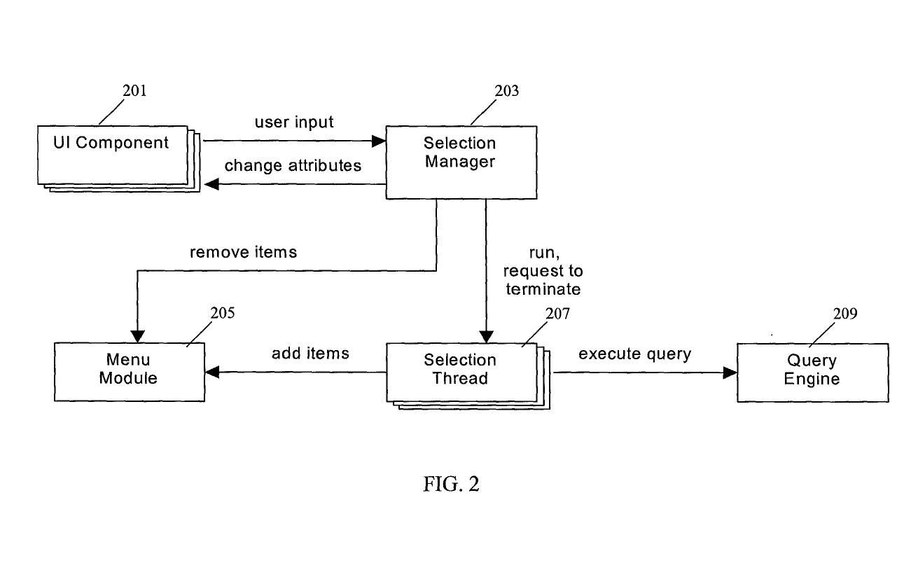

Referring again to the drawings, and in particular to FIG. 2, there is shown a block diagram of a service manager and its relationships to other program components. As with any GUI, there is a user interface (UI) component 201. The UI component displays graphics objects in a windows-based environment and collects user input. The user input is sent from the UI component 201 to the selection manager 203, as illustrated in FIG. 2. The selection manager 203 is a module that processes user-input actions related to the selection of graphic objects. The selection manager 203 changes graphics display attributes of selected objects by sending a request to the UI component 201 or runs or terminates a selection thread 207. The selection manager also requests the removal of items from the menu module 205. The selection thread 207 is a thread that retrieves the information necessary to enable the respective menu items for the selected object. The selection thread 207 requests queries in synchronous mode to the query engine 209 to execute queries. The query engine 209 executes many time-consuming queries. The menu module 205 manages the structure of the menu and displays menu items in a program's window. Both the selection manager 203 and selection thread 207 access the menu module 205.

A number of definitions will aid in the understanding of the method as described with respect to the exemplary embodiment.

1. A “graphic object” is a region on the screen that represents a certain element in the subject area. The program allows the user to operate with elements of the subject area through associated graphic objects. Graphic objects are implemented using UI components.

2. A “selected graphic object” is an object on which the program can perform a certain set of actions. These actions are defined using the menu. When a user selects an action from the menu, and this action is applicable for the selected graphic object, the action is applied to that graphic object. A graphic object becomes selected when a selection mark is placed on it, and becomes not selected when this mark is removed. A selected graphic object is visually distinguishable from other objects.

For the purpose of simplification, it is assumed that there is only one graphic object at a time that can be selected. However, it will be apparent to one skilled in the art that this mechanism can be easily modified to support multiple selected graphic objects (“multiple selection”).

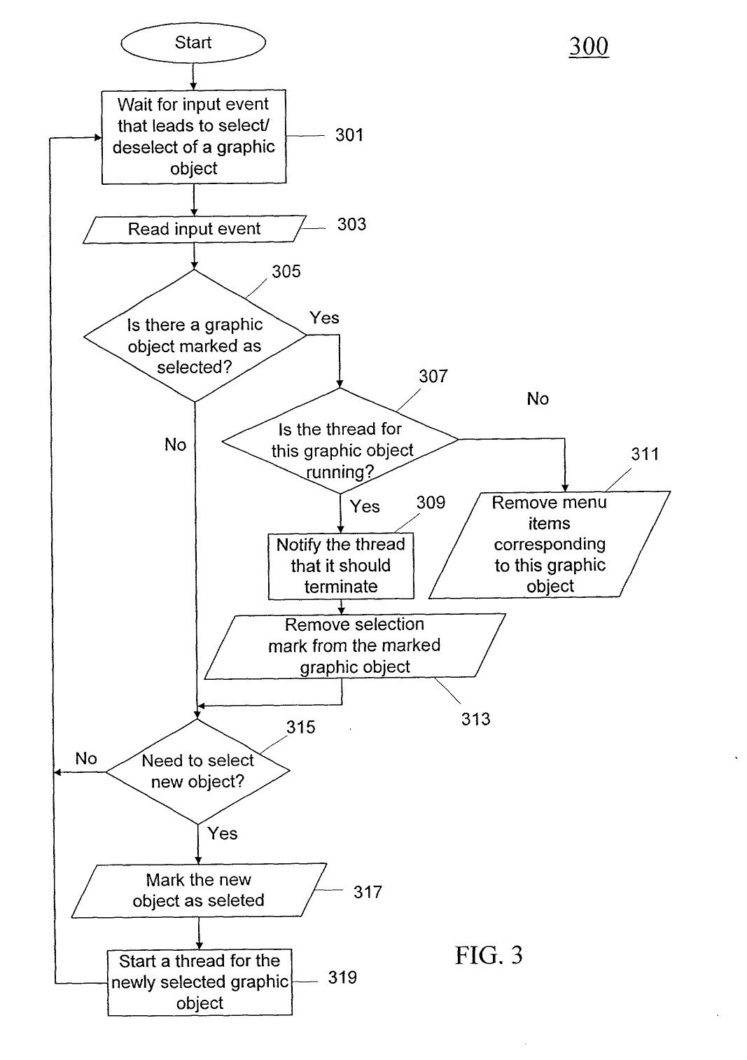

Referring now to FIG. 3, there is shown a flow chart generally designated by the reference numeral 300, illustrating the main loop run by the selection manager. The selection manager waits for input events that lead to deselecting or selecting a graphic object in block 301. The input events can be initiated directly by the user or by some part of the program. Other input events are processed by other modules of the program. The selection manager keeps selection threads associated with selected objects. When the program starts, there are no selected objects and no selection threads.

When an input event arrives, it is read in block 303. The selection manager then checks if there is a selected graphic object in block 305. If there is, it checks if the selection thread for this object is running in block 307. If it is running, the selection manager sends the “terminate” notification to the running selection thread in block 309. If the thread is not running, it means that it has finished execution and created menu items for the selected object. In this case the selection manager removes the menu items created by the thread in block 311. Regardless of whether the thread was running, the selection manager removes the selection mark from the previously selected object in block 313. If the input event contains the selection of a new graphic object, as determined in block 315, the selection manager marks, or flags, that object as selected in block 317 and creates a new selection thread for it in block 319. This entire loop cycle is reasonably fast since no time-consuming computations are performed in it.

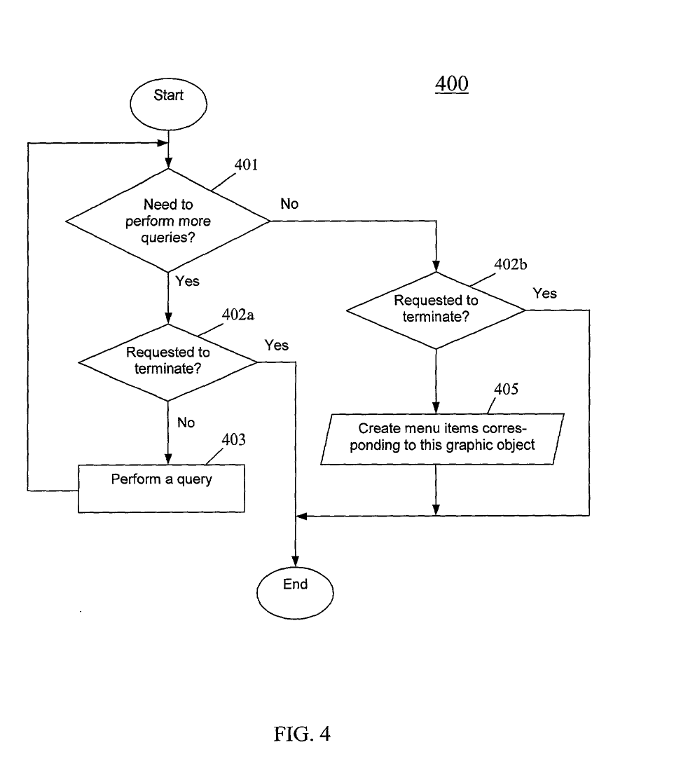

Referring now to FIG. 4, there is shown the selection thread process, generally depicted by the reference numeral 400. The selection thread performs a number of queries by passing them to the query engine and waiting for a result. Based on the result data it creates the menu items. The selection thread can be requested to terminate at any time. The thread must not perform any queries after it has received a request to terminate.

With reference again to FIG. 4, the thread determines whether additional queries are required in block 401. If it has been requested to terminate, as determined in blocks 402a and 402b, then no more queries are performed and the thread processing is complete. If, however, there is a need to perform additional queries, as determined in block 401, and no terminate request has been received, the next query is performed in block 403. Processing then loops back and continues with block 401. If no additional queries are required, and no terminate request has been received, then the menu items corresponding to this graphic object are created in block 405. In the exemplary embodiment, the thread cannot terminate in the middle of a query. This is due to the design of the query engine. It will be apparent to one skilled in the art that other query engine implementations could allow a query to terminate while executing.

Since the selection thread creates menu items only after the computations are complete, the actions for the selected object will become available to the user after a certain time. This, however, does not prevent the user from selecting other available menu items, or from selecting another graphic object.

An implementation of the present invention must consider thread safety and synchronization issues. A preferred embodiment is written in JAVA™, and these problems are resolved easily using the synchronization mechanisms provided by the language, as described below.

The “terminate” request is implemented using a variable with synchronized access in selection thread. The selection manager sets this variable to true, and the selection thread checks the value of this variable before each query and before creating menu items. The “running” flag of the selection thread is implemented by another variable with synchronized access. The program block containing “Requested to terminate?” 402b and the following “Create menu items . . . ” 405 in the selection thread (FIG. 4) is mutually exclusive with program block “Is thread . . . running?” 307 through “Remove menu items . . . ” 311 in the selection manager (FIG. 3).

Having described preferred embodiments of a novel method for a multi-threaded efficient design mechanism allowing dynamic generation of menus when selecting a graphical object (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and particularity required by the patent laws, what is claimed and desired protected by Letters Patent is set forth in the appended claims.

What is claimed is:

1. A system allowing dynamic generation of display objects when selecting a graphical object, comprising:
a user interface component for receiving user input and displaying and selecting graphics objects;
a query engine for querying a database for status and data related to graphic objects;
a display object module for managing display object structure and displaying display object items in a display;
a selection thread for requesting queries in synchronous mode to the query engine, and for adding items to display objects corresponding to an executing thread, the display object items being based on data retrieved by the query engine and a selected graphic object; and
a selection manager for managing execution and termination of program threads, and for removing display object items corresponding to terminated threads through the display object module.

2. A system as recited in claim 1, wherein display objects displayed through the display object module are dynamically generated pop-up menus.

3. A system as recited in claim 2, wherein the selection thread communicates with the display object manager for generating menu items.

4. A system as recited in claim 2, wherein the selection manager terminates threads after a query has completed.

5. A system as recited in claim 2, wherein the selection manager terminates threads before a query has completed.

6. A system as recited in claim 5, wherein the waiting thread begins executing after receiving a notification from the selection manager.

7. A system as recited in claim 2, wherein the selection manager terminates an executing thread when a second thread indicates a waiting status, and when the executing thread completes termination, the selection manager sends a notification to the waiting thread.

8. A computer implemented method for allowing dynamic generation of display objects when selecting a graphical object in a graphical user interface, comprising steps of:
selecting at least one graphical object on a graphical user interface display;
querying a database for data corresponding to the at least one selected graphical object;
dynamically generating a display object based on the at least one selected graphical object and corresponding data retrieved by the querying step, wherein the generating may be interrupted if a second graphical object is selected prior to completion of the generation of the display object; and
displaying the display object.

9. A computer implemented method as recited in claim 8, wherein the display object is a menu.

10. A computer implemented method as recited in claim 9, further comprising:
waiting for the selecting of at least one graphical object by a selection manager module;
responsive to the selecting of at least one graphical object,
determining whether a thread for a previously selected graphical object is running;
removing menu items corresponding to the previously selected graphical object, if a thread is not running for the previously selected graphical object;
sending a notification to terminate to a currently executing thread, if any;
executing a new thread for the newly selected at least one graphical object.

11. A computer implemented method as recited in claim 10, wherein the threads are Java programming language threads.

12. A computer implemented method as recited in claim 9, further comprising:
removing a selection mark from the previously selected graphical object; and
marking the newly selected at least one graphical object with a selection mark.

13. A computer implemented method as recited in claim 9, wherein dynamically generating a display object comprises:
determining a type associated with the at least one selected object;
identifying queries to determine status of the at least one selected object;
identifying queries to retrieve data corresponding to at least one selected object and the status of the at least one selected object; and
creating menu items based on the retrieved data corresponding to the at least one selected graphical object and status.

14. A memory for storing data for access by a graphical user interface application program being executed on a data processing system allowing dynamic generation of display objects when selecting a graphical object, comprising:
a user interface component stored in memory, the user interface component receiving user input and displaying and selecting graphics objects;
a query engine component stored in memory, the query engine querying a database for status and data related to graphic objects;
a display object component stored in a memory, the display object component managing display object structure and displaying display object items in a display;
a selection thread component stored in memory, the selection thread component requesting queries in synchronous mode to the query engine, and adding items to display objects corresponding to an executing thread, the display object items being based on data retrieved by the query engine and a selected graphic object; and
a selection manager component stored in memory, the selection manager component managing execution and termination of program threads, and removing display object items corresponding to terminated threads via the display object module.

15. A computer readable medium containing code sections for storing data for access by a graphical user interface (GUI) application program being executed on a data processing system allowing dynamic generation of display objects when selecting a graphical object, comprising:
a first code section comprising a user interface component, the user interface component receiving user input and displaying and selecting graphics objects;
a second code section comprising a query engine component, the query engine querying a database for status and data related to graphic objects;
a third code section comprising a display object component, the display object component managing display object structure and displaying display object items in a display;
a fourth code section comprising a selection thread component, the selection thread component requesting queries in synchronous mode to the query engine, and adding items to display objects corresponding to an executing thread, the display object items being based on data retrieved by the query engine and a selected graphic object; and
a fifth code section comprising a selection manager component, the selection manager component managing execution and termination of program threads, and removing display object items corresponding to terminated threads via the display object module.
